(19) United States
(12) Patent Application Publication
(10) Pub. No.: US 2015/0185767 A1
(43) Pub. Date: Jul. 2, 2015

(54) ELECTRONIC DEVICES WITH INTEGRATED LENSES

(71) Applicant: Arvind S., Bangalore (IN)

(72) Inventor: Arvind S., Bangalore (IN)

(21) Appl. No.: 14/142,485

(22) Filed: Dec. 27, 2013

(51) Int. Cl. G06F 1/16; B29C 45/00

(52) U.S. Cl. CPC G06F 1/1605; B29C 45/0055; B29K 2033/12

(57) ABSTRACT

A computing device having a display panel, a cover layer having an integrated lens (e.g., a Fresnel lens), and a sensor associated with the lens. The cover layer having the integrated lens may be a display cover disposed over the display panel, or a speaker grille disposed over a speaker of the computing device. The display cover may be polymethylmethacrylate (PMMA) or polycarbonate. The speaker grille may be high density polyethylene (HDPE) or polycarbonate, for example.

### TECHNICAL FIELD

The present techniques relate generally to integrating lenses in covers or cover layers of electronic devices and, more particularly, but not exclusively, to integrating lenses into display covers and speaker grilles of computing devices.

### BACKGROUND ART

The competitive business of consumer electronics drives manufacturers in the continuous improvement of their processes and products in order to lower production costs, increase product quality, and improve user experience of the products. Indeed, as technologies advance with electronic devices such as computing devices including all-in-one systems, mobile devices, and other computing devices and platforms, a competitive need exists to continuously improve form and ergonomics of the devices, including reducing their width and weight.

It is generally desirable for the computing devices to be relatively thin and light in weight, so to improve handling and user experience, and to reduce costs associated with the manufacture and operation (including power consumption) of the devices. Also, larger displays should generally be accommodated where desired. These computing devices may include desktop personal computers (PCs), all-in-one (AIO) computers, tablet devices, smartphones, laptop computers, and the like.

For many computer systems, such as AIO computer systems, the display may be the most visible and important component. Large and bright displays use substantial amounts of power and can be both thick and heavy. However, these characteristics can be challenging with a portable system. In all, whether a desktop, home system or a portable system, it is generally beneficial that the computing devices be thinner and weigh less to improve user experience, and to lower manufacturing and operating costs.

### BRIEF DESCRIPTION OF DRAWINGS

FIG. 1 is a perspective view of a computing device in accordance with embodiments of the present techniques.

FIG. 2 is a representation of a side sectional view of a laminated display stack forming a display 200 having a display cover in accordance with embodiments of the present techniques.

FIG. 3 is a diagrammatical representation of an exploded view of components of a computing device.

FIG. 4 is a diagrammatical representation of an exploded view of components of a computing device in accordance with embodiments of the present techniques.

FIG. 5 is a diagrammatical representation of a lens in accordance with embodiments of the present techniques.

FIG. 6 is a diagrammatical representation of a Fresnel lens in accordance with embodiments of the present techniques.

FIG. 7 is block flow diagram of method of manufacturing a cover having an integrated lens for a computing device in accordance with embodiments of the present techniques.

FIG. 8 is block flow diagram of method of manufacturing a computing device having a cover with an integrated lens in accordance with embodiments of the present techniques.

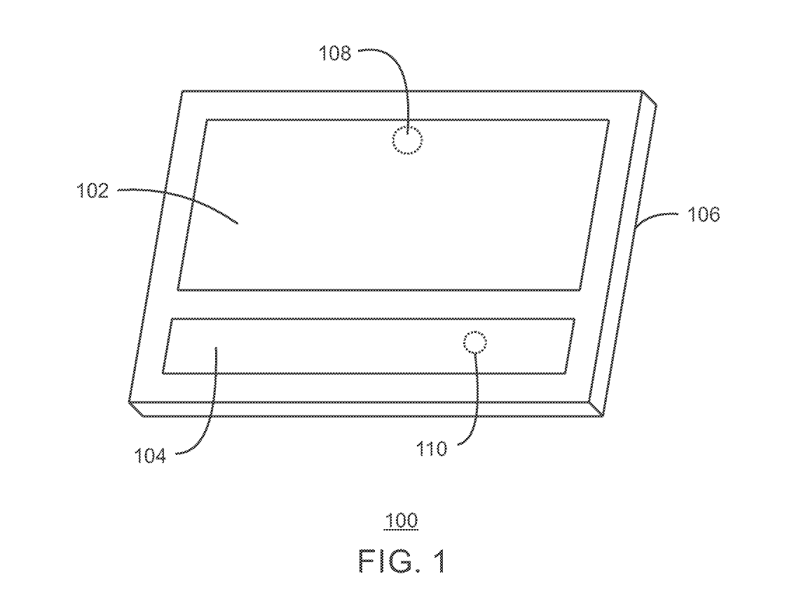

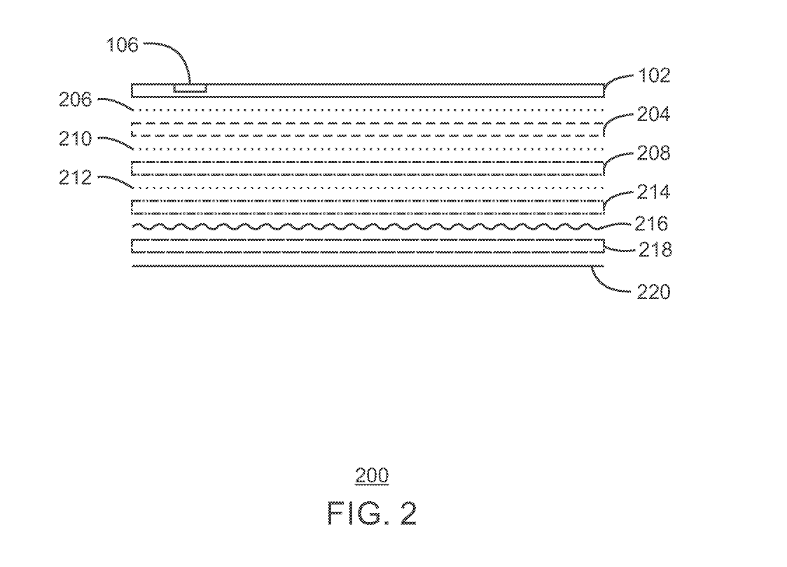

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

Many electronic devices including computing devices have one or more sensors requiring a lens. Conventionally, the lenses unfortunately increase the width and weight of the computing devices. Accordingly, embodiments of the present techniques integrate one or more of the lenses into a layer of the computing device, such as into the display cover and/or speaker grille of the computing device. Thus, the width and weight contribution of the lenses to the computing device may be in effect lowered, such as in comparison to the lenses occupying a separate dedicated space in the computing device, for instance. Consequently for the computing device, costs may be reduced, user experience improved, and optical performance increased, as discussed below.

Electronic devices including computing devices may have one or integrated cameras, ambient light sensors (ALS), infrared (IR) sensors including passive infrared (PIR) sensors, proximity or presence sensors, and other sensors. As appreciated by one of ordinary skill in the art, ambient light sensors, for example, can adjust a display's backlight, which improves user experience and power savings by promoting the display's viewability. Such ALS sensors may approximate the human eye response to light under a variety of lighting conditions. As for infrared sensors, they may include infrared proximity sensors, for example. A passive infrared sensor (PIR sensor) is an electronic sensor that measures infrared (IR) light radiating from objects in its field of view, and may be used PIR-based motion detection, for instance. The cameras and sensors (e.g., an integrated circuit, complementary metal-oxide-semiconductor or CMOS, thermopile, photodiode, etc.) may need lenses to perform the act of focusing light from objects of interest or environment onto the cameras and sensors. Embodiments of the present techniques are directed to integrating and forming such lenses with an existing layer of the computing device.

Lenses may be relatively expensive and conventionally a separate part to be assembled in the computing device, adding cost and having a finite thickness which increases the computing device thickness. In contrast, embodiments herein to integrated the lenses into an already-utilized layer (e.g., cover) of the computing device may mitigate cost and thickness contributions of the lenses, resulting in a less-costly and thinner overall system. Techniques in the present disclosure may leverage existing parts (e.g., display cover, speaker grille, etc.) within the system and increase their functionality, i.e., by incorporating lenses into those parts. Therefore, lenses as a separate component (which are often expensive parts of a system) may be avoided. In fact, because the present lenses are formed as part of the display cover (or speaker grille) within the thickness of the system, overall thickness of the system may be reduced. As indicated, this lens integration into a cover may also reduce cost and weight. Further, optical performance may be improved at least due to a less amount of material through which light passes before hitting the sensor in certain examples. The display cover glass or cover lens material can be anything including glass (treated or untreated—such as Gorilla/dragon trail types or simple soda lime, to name a few examples.

Lenses for computing devices and systems may fall into basic categories. One category is lenses optically clear and transparent at visible wavelengths, such as lenses for RGB (red, green, blue) cameras and ALS sensors. Thus, these lenses may benefit from becoming part of an optically transparent display cover (as opposed to becoming part of an optically non-transparent speaker cover grille, for example). Another category is lenses of sensors depending on IR transparency which may not need visible wavelength transparency. Examples of such sensors may include PIR sensors, camera depth sensors, and the like. Lenses in this basic category for sensors relying on IR transparency may be integrated (become a part of) the display cover or speaker grille including with the speaker grille not optically transparent in certain embodiments.

Computer devices and systems generally include a display and optionally an accompanying or integrated speaker. While a display cover and speaker grille may be present in the system, lenses associated with the sensors have traditionally been assembled as separate units in addition to the display cover and speaker grille. Conversely, in accordance with embodiments of the present disclosure, the lenses (or a portion of the lens system—as in cameras) are integrated into or onto the display cover (as in the case of visible light transparent lenses). Infrared transparent lenses may be integrated onto the speaker grille in the system, or onto the display cover. Moreover, Fresnel lenses may be employed to achieve the same or similar level of optical performance as traditional lenses while giving thinner system profiles (with the Fresnel lenses integrated in the thickness of the display cover or speaker grill thickness with no or little additional thickness adder).

As the covers of the display may be plastic (e.g., polymethylmethacrylate or PMMA) and the speaker grille material also plastic, the lens (e.g., Fresnel lens) impression may be directly hot-pressed onto the bottom surface of these panels, for example. In other examples, the Fresnel lens may be formed in extrusion of the display cover or speaker grille. In yet other embodiments, the lens may be formed within the display cover in the cell casting of the display cover. In an example of cell-casting PMMA for the display cover, the polymerization of the PMMA and forming of the display cover with the integrated lens may occur in the same process (die) at substantially the same time.

In all, the lens may be formed inside the cover and perform the same or similar as a traditional separate lens but without the thickness addition of a lens as a separate component. Further, because the optics (lenses) are formed as part of the display cover or speaker grill, little or no additional and expensive lens material need be assembled in certain instances.

FIG. 1 is an exemplary computing device 100 having a display and a display cover 102 layer. The display cover 102 may be part of the display or display panel. In embodiments, the computing device 100 may have a touch sensor so that the display underlying the display cover 102 is a touchscreen display. Further, in the illustrated embodiment, the computing device 100 has a speaker with an exemplary speaker grille 104 (speaker cover).

The computing device may be a smartphone, personal digital assistant, tablet, laptop, all-in-one (AIO) computer, portable AIO (pAIO) device, computer monitor, television system, medical device, process control computer, and so forth. The computing device 100 may have physical and/or virtual buttons or controls (not shown). A width dimension of the computing device 100 is indicated by reference numeral 106.

The display cover 102 may be glass or plastic (polymer), for example. Beneficially, a plastic display may generally be lighter in weight than glass. Examples of plastic or polymer material for the display cover 102 include scratch-resistant plastics such as polymethylmethacrylate (PMMA), polycarbonate, and the like. In some cases, the display cover 102 may include an added scratch resistant coating. As for the exemplary speaker grille 104, it may be high-density polyethylene (HDPE), polycarbonate, or other materials.

The PMMA may be of particular interest as a material for the display cover 102 due to the transparency and other properties of PMMA. Polymethylmethacrylate (PMMA) is the homopolymer of methyl methacrylate (MMA), and is often formulated as a copolymer where another monomer is employed in weight percent concentrations up to 10% and higher. The PMMA may be produced by emulsion polymerization, solution polymerization, and bulk polymerization. Generally, radical initiation is used (including living polymerization methods), but anionic polymerization of PMMA can also be performed. Notably, PMMA produced by radical polymerization (generally most commercial PMMA) is atactic and amorphous.

As for physical properties, PMMA (known by trade names Plexiglas™ and Lucite™, for example) generally combines stability and chemical resistance with desirable optical properties (transparency), moldability (castable and machinable), and is generally tough and substantially shatterproof. Plasticizers may be added to improve processing properties, lower the glass transition temperature, or improve impact properties of the PMMA.

In the illustrated example of FIG. 1, an integrated lens 108 may be formed as part of the display cover 102 layer. Similarly, an integrated lens 110 may be formed as part of the speaker grille 104. Advantageously, integrating the lenses as part of the display cover 102 and/or speaker grille 104 may reduce the width and weight of the computing device 100 (as compared, for example, to configurations having separate lenses disposed between layers of the computing device).

While a display cover 102 as glass (inorganic traditional glass) may accommodate an integrated lens formed therein, plastics such as polycarbonate or PMMA material for the display cover 102 typically offer more formability than glass in fabricating the display cover 102 and the lens 108 as one component. Indeed, the malleability of the plastic facilitates formation of the display cover 102 and the lens 108 as the same structure. After all, the glass transition temperature Tg and melt temperature are typically less for plastic than glass, and plastic may be less breakable than glass in processing to accommodate an integrated lens. However, again, the present techniques may accommodate a cover 102 that is glass (inorganic traditional glass) and having a lens 108 integrate therein.

As for PMMA, the glass transition temperature (Tg) of atactic PMMA is about 105° C. (221° F.). The Tg values of commercial grades of PMMA may range from 85 to 165° C. (185 to 329° F.). The range is relatively wide because of the relatively large number of commercial compositions (including copolymers made with comonomers in addition to methyl methacrylate). Moreover, PMMA is thus generally an organic glass at room temperature, in that the PMMA Tg is above room temperature (ambient temperature).

In processing of the PMMA, the forming temperature generally starts at the glass transition temperature, and formability increases as the processing temperature is further raised above the Tg. Common molding processes of PMMA may include injection molding, compression molding, and extrusion. The PMMA products may also be formed by cell casting, where the polymerization and molding steps occur generally concurrently.

To fabricate the display cover 102 structure to be installed in the computing device 100, a die may first be constructed having the form of the display cover 102 with a cavity or area for the lens 108 imprint. The die may then be used in extrusion or molding of the display cover 102. The lens 108 imprint cavity or area may be located at the desired location along or in the display cover 102 shape of the die.

To fabricate the display cover 102 using the die, the plastic may be extruded or molded (e.g., injection molded, compression molded or hot-pressed, etc.) in or against the die to form a single plastic component in the shape of the display cover 102 having the lens 108 (with the lens 108 in the desired location in the display cover). In cases of extrusion and injection molding, the plastic (e.g., beads, pellets, or powder) may be heated and processed in the die as softened or a melt to the shape of the die, and then cooled to harden. The solidified plastic may then be removed from the die to give the display cover 102 component having the integrated lens 108. For compression molding or hot press, a sheet of plastic, for instance, may be first cut and the lens 108 shape imprinted via heat and pressure on the plastic sheet to give the display cover 102 component having the integrated lens 108. The aforementioned die or similar processing device with the lens 108 shape may be used to make the imprint.

Lastly, a casting technique (e.g., cell-casting) with PMMA or similarly-polymerized plastics, may be performed to form the display cover 102 having the lens 108 integrated therein. In the cell-casting process with PMMA, acrylic monomer (MMA or “resin”) which is generally a bulk chemical, may be poured or placed, along with any comonomer and catalyst (e.g., a polymerization catalyst such as methyl ethyl ketone peroxide or MEKP), into a mold or die to produce a display cover 102 of hardened transparent PMMA. The mold or die is configured to give the shape of the display cover 102 having the lens 108. In embodiments, during the cell-casting, the mold die having the PMMA material may be placed into curing tanks, followed by placement in a post-curing oven, for instance, to provide for desired heat transfer. In examples, the mold die may then be subsequently cooled and disassembled, and the formed display cover 102 removed.

In certain embodiments, in the ensuing installation of the display cover 102 (having the integrated lens 108 formed therein) into the computing device 100, the display cover 102 may be bonded to a sensor grid, which can provide support. Consequently, a hard grade of PMMA, in spite of higher brittleness, may be used as the material for display cover 102 in some examples, improving the user experience while maintaining a scratch resistant surface. The use of PMMA or similar plastic material may also lower display power, since more light may typically be transmitted through the cover 102 made of PMMA, as compared to a cover 102 made of glass, for example. Further, beneficially, PMMA is generally lighter in weight than glass.

FIG. 2 is a side sectional view of a laminated display stack forming a display 200 having a display cover 102, and such that may be employed in examples of the computing device 100 of FIG. 1. However, it should be emphasized that the display 200 depicted in FIG. 2 is only one example, and not meant to limit the present techniques associated with integrating lenses into a display cover 102 (or in the speaker grille 106 of FIG. 1).

As discussed, the display cover 102 may be a scratch-resistant plastic material, such as a PMMA, polycarbonate, or other material, either alone or in a laminated structure, including with a scratch resistant coating, for instance. As also mentioned, the display cover 102 may have an integrated lens 108 formed as part of the display cover 102. Further, a sensor (not shown) associated with and utilizing the lens 108 may be disposed in the display 200 (the sensor generally disposed behind the lens 108).

The display cover 102 panel can be attached to an optional touchscreen sensor 204 by an adhesive layer 206. In one embodiment, the touchscreen sensor 204 is a metal mesh. In addition to sensing touch, the metal mesh can provide mechanical support to the display panel cover 202, e.g., the PMMA, facilitating the formation of a stiffer display and the use of more brittle and scratch resistant plastic grades. Further, an optional stylus antenna 208 can be attached to, and insulated from, the touchscreen sensor 204 by a second layer 210 of adhesive. In embodiments, the stylus antenna 208 may accept input from two or more styluses at once. Another layer 212 of adhesive may affix a display panel 214 to the structure.

The display panel 214 can be a liquid-crystal display (LCD) panel or an organic light-emitting diode (OLED) panel, as known in the art. If an OLED panel is used, no further layers may be needed in certain examples. If an LCD panel is utilized as the display panel 214, it may include multiple layers, such as a top polarizer, a conducting film (CF) glass, a thin-film transistor (TFT) panel, another CF glass, and a bottom polarizer, among others. Further, if the display panel 214 is an LCD panel, additional layers are used below the display panel 214 to light the panel and increase the brightness.

For example, a brightness enhancement film (BEF) 216 can be placed behind the display panel to increase the light sent through the panel. The BEF 216 can be a prismatic film that directs more light through the display panel. Multiple layers and combinations of these films can be used as the BEF 216. A light source 218, such as a light guide that is illuminated by a light emitting diode (LED) array or fluorescent tubes, can be placed behind the BEF 216 to provide illumination for the display panel 214. A reflector 220 can be placed behind the light source to increase the amount of light that passes through the display panel 214.

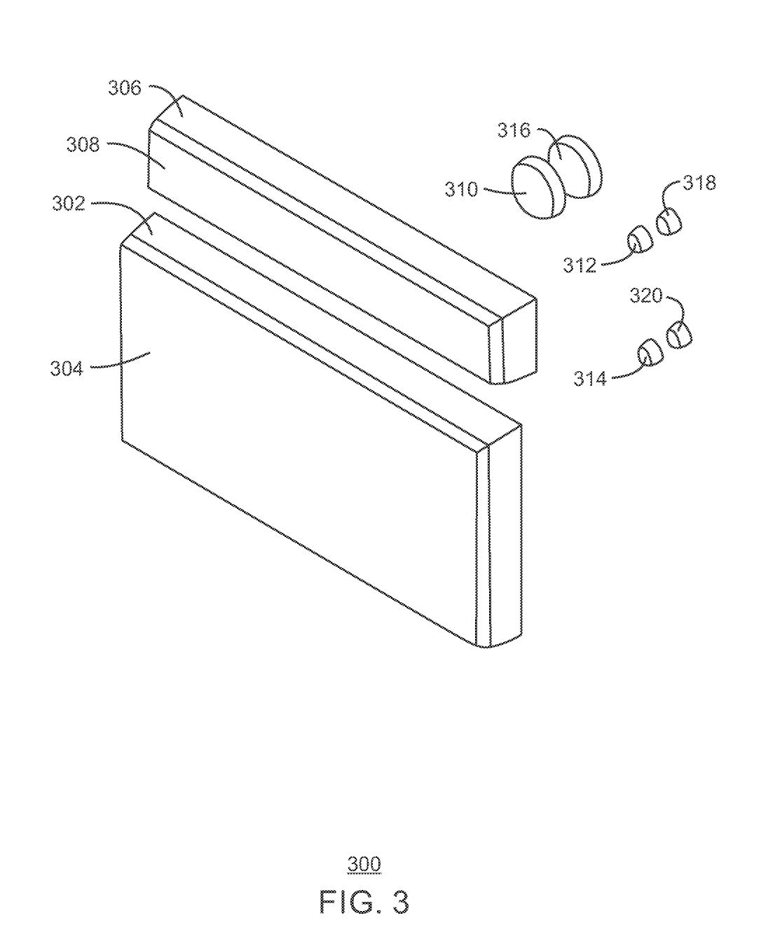

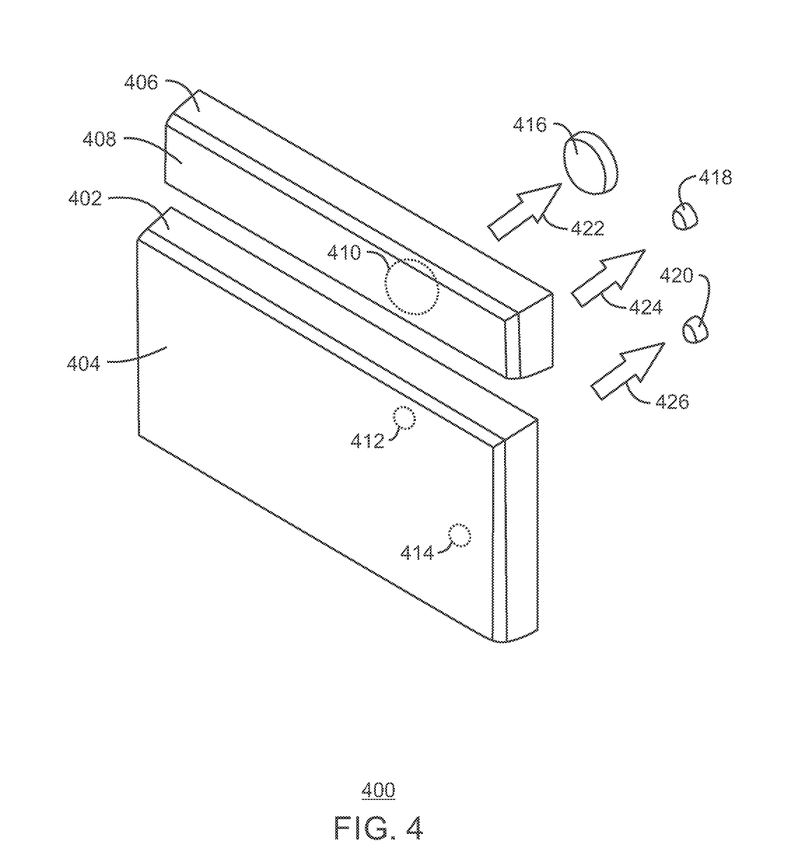

FIGS. 3 and 4 are conceptual exploded views of components of exemplary computing devices 300 and 400, respectively. As with the computing device 100 of FIG. 1, the computing devices 300 and 400 may be a smartphone, tablet, laptop, AIO computer, pAIO device, computer monitor, television, and so forth. The computing devices 300 and 400 may optionally have a touch sensor so that the displays 302 and 402 of the computing devices 300 and 400 may be a touchscreen display. The displays 302 and 402 generally have a display panel (e.g., LCD, open cell, OLED, etc.) and one or more of the layers mentioned above with respect to FIG. 2.

The computing device 300 of FIG. 3 has a display 302 with a display cover 304, and a speaker 306 with a speaker grille 308. Three lenses 310, 312, 314 and associated sensors 316, 318, and 320, respectively, are components in the computing device 300. The lenses 310, 312, 314 in this conventional example of FIG. 3 are not integrated or formed with an existing layer (e.g., cover) of the computing device 300. Therefore, unfortunately, the lenses 310, 312, 314 may generally increase the weight and width of the computing device 300 (and display 302). Indeed, these lenses 310, 312, 314 may add to the weight, thickness, cost and complexity of the sensor modules.

In contrast and in accordance with embodiments of the present techniques, the computing device 400 of FIG. 4 has lenses integrated and formed with other layers (e.g. cover(s)) of the computing device 400. Therefore, the width of the computing device 400 may be reduced. Again, these lenses have optical clarity and performance that suits the particular sensor. For instance, a RGB camera sensor benefits from a visible light transparent lens with optical characteristic that may match that of a convex lens to name just one example.

In reference to FIG. 4, the computing device 400 has a display 402 with a display cover 404, and a speaker 406 with a speaker (cover) grille 408. Further, the computing device 400 includes three lenses 410, 412, 414 and associated respective sensors 416, 418, and 420. Of course, the computing device 400 may have more or less number of lenses (and associated sensors) than the three lenses depicted.

In the illustrated embodiment, the lens 410 is integrated in and formed with the speaker grille 408 but remains associated to and operationally interfacing with the sensor 416, as indicated by arrow 422. Additionally, in this example, the two remaining lenses 418 and 420 are integrated in and formed with the display cover 404. The lenses 412 and 414 are associated with and operationally support the respective sensors 418 and 420, as indicated by arrows 424 and 426, respectively. Generally, lenses may be formed on the display cover or speaker grille material depending on visual light transmission requirements. For example, an RGB camera or ALS may have their associated lens formed on a PMMA display cover 102 with exceptional visible light transmission. On the other hand, a PIR sensor and IR camera may have have Fresnel lens formed on a speaker grille made of IR transparent material like polycarbonate/HDPE instead of PMMA.

As indicated above throughout the description, various exemplary techniques for the integration and formation of the lenses in and with cover layers in computing devices are applicable. Likewise, various materials of construction are applicable. The aforementioned PMMA (a transparent thermoplastic) may be a desirable material for the display cover 102, 402 (having a lens formed therein) because of beneficial PMMA properties. Such properties including relatively lower weight, good scratch and impact resistance, good strength, and so on. Further, the addition of comonomer during polymerization of the PMMA, or the addition of additives (e.g., plasticizer) post-polymerization, to give a modified PMMA, may further improve these properties. In all, PMMA may be used as a lightweight or shatter-resistant alternative to glass. Moreover, a display cover 102 of PMMA may be more moldable and prone to formation of a lens within the display cover 102.

For the particular cases of forming the display cover 102, 402 and integrated lens 108, 412, 414, including of PMMA material, the aforementioned techniques of extrusion, injection molding, compression molding, hot press, and cell-casting may be applicable. Similarly, for forming the speaker grille 104, 408 and integrated lenses 110, 410, including as HDPE and/or polycarbonate, for instance, the forming processes of extrusion, injection molding, and other processes may be applicable.

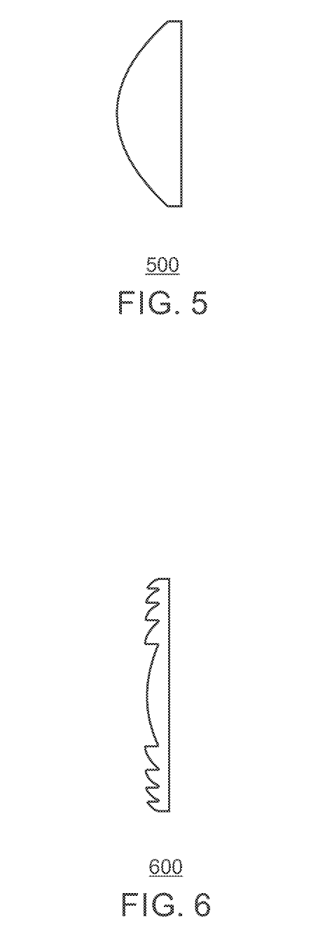

FIG. 5 is a cross-section of a spherical or substantially spherical lens 500 and indicating general shape of a lens 500 that may be integrated with and formed with a layer (e.g., a cover layer) of a computing device. In alternate examples, the lens 500 may be cylindrical. In the illustrated example, the lens 500 is a convex lens with a convex surface. However, the lens 500 may instead have two convex surfaces. Moreover, the lens may instead be a concave lens with one or two concave surfaces. Further, the lens 500 may be of the simple lens type, for instance. Other lens configurations are applicable to the present techniques.

FIG. 6 is a cross-section of a spherical or substantially spherical lens 600 and indicating general shape of a lens 600 that may be integrated and formed with a layer (e.g., a cover layer) of a computing device. In the illustrated embodiment, the lens 600 may be a Fresnel lens or a similar-type lens. Such a Fresnel-type design may facilitate construction of lenses of relatively large aperture and short focal length with less mass and volume than conventional lens designs. Indeed, a Fresnel lens is typically significantly thinner than a comparable conventional lens. In fact, exemplary thicknesses of Fresnel lenses can be as small as in the 1 to 5 millimeter (0.039 to 0.20 inch) range, for instance.

Thus, the Fresnel-lens design reduces the amount of material required for a lens as compared to a conventional-lens design by dividing the lens into a set of concentric annular sections. A theoretically ideal Fresnel lens would have infinitely many such sections. In each section, the overall thickness is decreased compared to an equivalent simple lens. This effectively divides the continuous surface of a standard lens into a set of surfaces of the same curvature, with stepwise discontinuities between them. In some Fresnel lenses, the curved surfaces are replaced with flat surfaces, with a different angle in each section. Such a lens can be regarded as an array of prisms arranged in a circular fashion, with steeper prisms on the edges, and a flat or slightly convex center.

Example application types of Fresnel lens may include imaging and non-imaging, and other types. Imaging Fresnel lenses generally employ curved segments and produce relatively sharp images, while non-imaging lenses employ flat segments, and may not produce sharp images. Notably, as the number of segments increases, these two types of lens become more similar to one another. In theory, with an infinite number of segments, the difference between curved and flat segments disappears.

It should be noted that the above characterization of Fresnel lenses is not meant to limit the present techniques. Other characterizations of Fresnel lenses are applicable. Lastly, in general, the foregoing lens types and shapes discussed above with respect to FIGS. 5 and 6 may apply to the lenses 108, 110, 310, 312, 314, 410, 412, 414 of the preceding FIGS. 1-4 in certain examples.

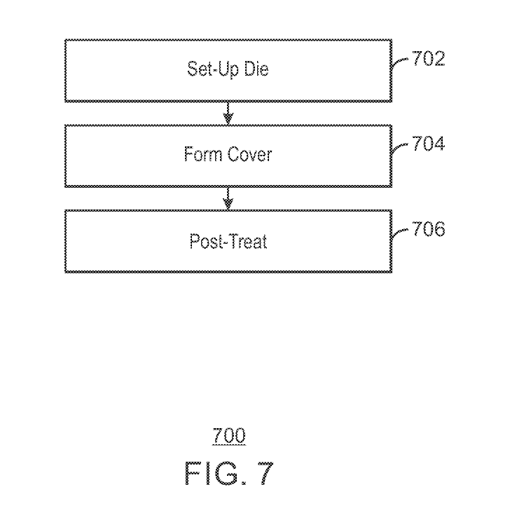

FIG. 7 is an exemplary method 700 of manufacturing a cover layer (having an integrated lens) for a computing device. The cover layer may be a display cover, for example, or a speaker grille in certain instances, or other layers of the computing device. At first, prior to implementing the method 700 and in order to manufacture the cover layer having an integrated lens, a die or mold die is obtained that gives the shape of the desired cover having an integrated lens. The die may be constructed to accommodate more than one integrated lens into the cover if needed.

Initially, the method 700 includes setting up (block 702) the obtained die or mold die. The particulars of the set-up may depend on the plastic molding process employed. For instance, in the case of extrusion, the die may be placed at the end of an extruder. Similarly, for injection molding, the die may be configured to receive a plastic melt. In the case of compression molding or hot press, the die may be positioned such as to facilitate heat transfer to and from the die. For cell-casting, the die may be positioned to receive monomer resin and catalyst, as well as to facilitate heat transfer to and from the die. Of course, other arrangements for setting-up or configuring the obtained die or mold die may be applicable.

After the die is in place and operationally ready, the method forms (block 704) the cover having the integrated lens by placing plastic in or against the die. As indicated, in extrusion or injection molding, the die receives a plastic melt. For extrusion, the process may be a plastic shaping process in which plastic is melted and then pushed out of the extruder or machine. As the plastic melt exits the machine, the die shapes the resin. In compression molding or hot press, the plastic such as a plastic sheet may be subjected to heat and pressure against the die to form the cover having the integrated lens(es).

As for cell-casting, the polymerization ingredients such as monomer, catalyst, and any comonomer are added to or placed in the die or mold die. The cover (e.g., PMMA display cover) may be produce in the die in batches. In certain examples, the die encompassing the polymerization and formation of the cover may be placed in ovens and water baths for heat transfer. In general, a cell-casting process generally concurrently polymerizes and forms the PMMA into the cover having the integrated lens(es).

Lastly, in the various processes of forming the cover (i.e., display cover, speaker grille, etc.), once the cover is formed in or against the die, the cover may be further treated, i.e., post-treated (block 706). The cover component may be subjected to post-treatment in the die or after removal from the die. Such post-treatment may include the removal of flashing, hardening treatment, annealing processing, and so forth. In all, the formed cover is removed from the die and ultimately ready for distribution and assembly into a computing device.

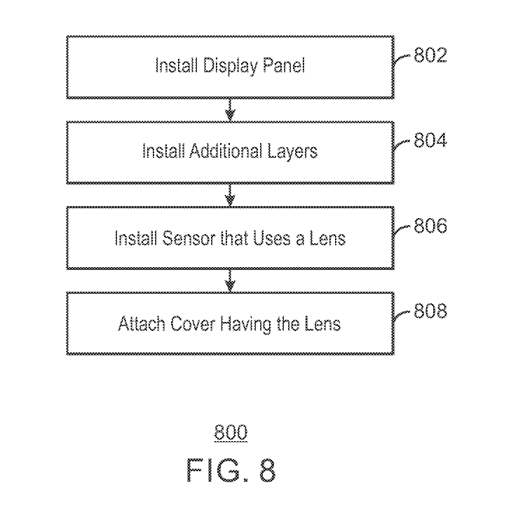

FIG. 8 is an exemplary method 800 of manufacturing a computer device having a lens integrated and formed with a layer (e.g., cover) of the computing device. At the outset, it should be noted that method 800 is plainly not inclusive of all actions in the manufacturing and assembling of a computer device. Further, the depicted actions of method 800 are not necessarily formed in the order given in FIG. 8. For example, a cover may be attached in the computing device prior to the display panel being installed. Also, a sensor layer or sensor that uses a lens may be installed prior to installation of the display panel, and after the cover is installed.

In method 800, a display panel is installed (block 802) in the computing device. Further, additional layers, such as those discussed with respect to FIG. 2, are installed (block 804) in the computing device. For the display panel and additional layers, an adhesive or other coupling means may be employed to install and attach the display panel and additional layers in the computing device. Furthermore, at least one sensor that uses a lens is installed (block 806) in the computing device. In embodiments, the sensor may be part of a sensor layer.

The method includes obtaining a display cover having an integrated lens(es) lenses for the sensor(s). The display cover may have been formed according to the general method 700 of FIG. 7, for example, and/or with respect to the techniques discussed generally herein for forming a display cover and the integrated lens(es) as the same structure or component. The cover (e.g., display cover, speaker grille, etc.) having such an integrated lens is installed or attached (block 808) to the computing device.

Those of ordinary skill in the art will recognize that, while embodiments relating to lenses are described herein, other embodiments may relate to optical focusing elements which could include curved surface reflection surfaces or Fresnel type lenses. Moreover, embodiments may relate to mirror types and not just lenses. In embodiments, examples of methods of forming optical focus elements may include either by hot impress for low temperature substrates, cell casting or rolling die for higher temperature substrates.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A computing device comprising:
a display panel;
a cover layer having an integrated lens; and
a sensor associated with the lens.

2. The computing device of claim 1, wherein the cover layer comprises a display cover disposed over the display panel.

3. The computing device of claim 1, comprising a speaker, wherein the cover layer comprises a speaker grille disposed over the speaker.

4. The computing device of claim 1, wherein the cover layer comprises polymethylmethacrylate (PMMA).

5. The computing device of claim 1, wherein the integrated lens comprises a Fresnel lens.

6. The computing device of claim 1, wherein the computing device comprises an all-in-one (AIO) computing device.

7. A computing device comprising:
a display panel;
a plastic structure forming a cover with an integrated lens; and
a sensor operationally coupled with the lens.

8. The computing device of claim 1, wherein the cover comprises a display cover layer.

9. The computing device of claim 1, comprising a speaker, wherein the cover comprises a speaker grille.

10. The computing device of claim 7, wherein the display panel comprises a liquid crystal display (LCD).

11. A method of manufacturing a cover layer having an integrated lens for a computing device, the method comprising:
obtaining a die giving a shape of the cover layer with the integrated lens for the computing device;
forming the cover layer in the die, wherein the cover layer comprises plastic; and
removing the cover layer from the die.

12. The method of claim 11, wherein the cover layer comprises a display cover to be disposed over a display panel of the computing device.

13. The method of claim 11, wherein the cover layer comprises a speaker grille to be disposed over a speaker of the computing device.

14. The method of claim 11, wherein the plastic comprises polymethylmethacrylate (PMMA) polymer.

15. The method of claim 11, wherein the integrated lens comprises a Fresnel lens.

16. The method of claim 11, wherein the computing device comprises an all-in-one (AIO) computing device.

17. The method of claim 11, wherein the plastic comprises PMMA, and wherein forming the cover layer having the integrated lens comprises cell-casting the PMMA in the die.

18. The method of claim 11, wherein forming the cover layer having the integrated lens comprises hot press of the plastic against the die to imprint the integrated lens in the plastic.

19. The method of claim 11, wherein forming the cover layer having the integrated lens comprises extrusion or injection molding of the plastic through the die.

20. A method of manufacturing a computing device having a cover layer with an integrated lens, the method comprising:
incorporating a display panel in the computing device;
installing a sensor in the computing device, the sensor using a lens; and
attaching a cover to the computing device, the cover having the lens integrated therein.

21. The computing device of claim 1, wherein the cover comprises a display cover layer.

22. The computing device of claim 21, wherein the display cover layer comprises polymethylmethacrylate (PMMA).

23. The computing device of claim 1, comprising installing a speaker, wherein the cover comprises a speaker grille disposed over the speaker.

24. The computing device of claim 1, wherein the lens comprises a Fresnel lens.

25. The computing device of claim 1, wherein the computing device comprises an all-in-one (AIO) computing device.
